(19) United States
(12) Patent Application Publication
(10) Pub. No.: US 2020/0326581 A1
(43) Pub. Date: Oct. 15, 2020

(54) COVER GLASS AND DISPLAY DEVICE

(71) Applicant: Japan Display Inc., Tokyo (JP)

(72) Inventor: Makoto Miyao, Tokyo (JP)

(73) Assignee: Japan Display Inc., Tokyo (JP)

(21) Appl. No.: 16/828,974

(22) Filed: Mar. 25, 2020

(30) Foreign Application Priority Data
Apr. 15, 2019 (JP) 2019-077169

(51) Int. Cl. G02F 1/1333; G02F 1/1335; G02F 1/1334

(52) U.S. Cl. CPC G02F 1/133308; G02F 2001/133331; G02F 1/1334; G02F 1/133553

(57) ABSTRACT

According to one embodiment, a cover glass has a first side surface and a second side surface facing the first side surface. A reflector is disposed on the second side surface. The reflector is not disposed on the first side surface. Surface roughness of the second side surface is greater than surface roughness of the first side surface.

### CROSS-REFERENCE TO RELATED APPLICATIONS

This application is based upon and claims the benefit of priority from Japanese Patent Application No. 2019-077169, filed Apr. 15, 2019, the entire contents of which are incorporated herein by reference.

### FIELD

Embodiments described herein relate generally to a cover glass and a display device.

### BACKGROUND

Recently, various illumination devices including light-modulating elements which exhibit scattering properties or transparency properties with respect to light have been proposed. For example, the light-modulating element includes a polymer dispersed liquid crystal layer as a light-modulating layer. The light-modulating element is disposed behind a light guide plate and scatters light which enters from a side surface of the light guide plate.

The light emitted from the light-emitting element enters the side surface of the light guide plate and leaks from the opposite side to the side surface to the outside of the light guide plate. Therefore, it is necessary to improve light use efficiency.

### BRIEF DESCRIPTION OF THE DRAWINGS

FIG. 1 is a plan view showing a configuration example of a display device DSP of the present embodiment.

FIG. 2 is a cross-sectional view showing a configuration example of a display panel PNL shown in FIG. 1.

FIG. 3 is a plan view showing a cover glass 30 and a light-emitting module 3 which are applicable to the display device DSP of the present embodiment.

FIG. 4 is a cross-sectional view showing a configuration example of the display device DSP of the present embodiment.

FIG. 5 is an illustration showing a configuration example of a second side surface 30D.

### DETAILED DESCRIPTION

In general, according to one embodiment, there is provided a cover glass having a first side surface and a second side surface facing the first side surface. A reflector is disposed on the second side surface. The reflector is not disposed on the first side surface. Surface roughness of the second side surface is greater than surface roughness of the first side surface.

According to another embodiment, there is provided a display device including a light-emitting element, a cover glass having a first side surface facing the light-emitting element and a second side surface facing the first side surface, a display panel comprising a polymer dispersed liquid crystal layer, and an adhesive layer bonding the cover glass and the display panel together. Surface roughness of the second side surface is greater than surface roughness of the first side surface.

The present embodiment will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, and the like of the respective parts are illustrated schematically in the drawings, rather than as an accurate representation of what is implemented, but such schematic illustration is merely exemplary, and in no way restricts the interpretation of the invention. In addition, in the specification and drawings, structural elements which function in the same or a similar manner to those described in connection with preceding drawings are denoted by the same reference numbers, and detailed explanations of them that are considered redundant may be arbitrarily omitted.

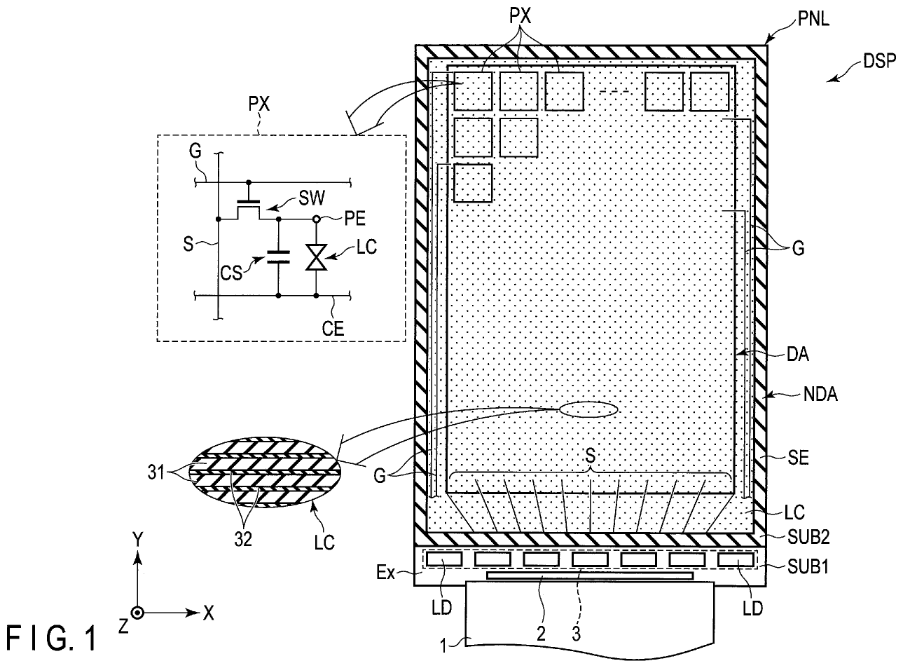

FIG. 1 is a plan view showing a configuration example of the display device DSP of the present embodiment. A first direction X, a second direction Y and a third direction Z are, for example, orthogonal to one another but may cross one another at an angle other than 90 degrees. The first direction X and the second direction Y correspond to directions parallel to a main surface of a substrate constituting the display device DSP, and the third direction Z corresponds to a thickness direction of the display device DSP. In the present embodiment, a view of an X-Y plane defined by the first direction X and the second direction Y will be referred to as planar view.

The display device DSP includes a display panel PNL including a polymer dispersed liquid crystal layer (hereinafter referred to simply as a liquid crystal layer LC), a wiring substrate 1, an IC chip 2 and a light-emitting module 3.

The display panel PNL includes a first substrate SUB1, a second substrate SUB2, the liquid crystal layer LC and a sealant SE. The first substrate SUB1 and the second substrate SUB2 overlap in planar view. The first substrate SUB1 and the second substrate SUB2 are bonded together by the sealant SE. The liquid crystal layer LC is held between the first substrate SUB1 and the second substrate SUB2 and is sealed by the sealant SE.

As shown in an enlarged schematic view within FIG. 1, the liquid crystal layer LC includes a polymer 31 and liquid crystal molecules 32. For example, the polymer 31 is a liquid crystal polymer. The polymer 31 is formed in the shape of a stripe extending in the first direction X and is arranged in the second direction Y. The liquid crystal molecules 32 are dispersed in gaps of the polymer 31 and are aligned such that their major axes are aligned in the first direction X. Each of the polymer 31 and the liquid crystal molecule 32 has optical anisotropy or refractive anisotropy. The responsiveness to an electric field of the polymer 31 is lower than the responsiveness to an electric field of the liquid crystal molecule 32.

For example, the alignment direction of the polymer 31 hardly changes irrespective of the presence or absence of an electric field. On the other hand, the alignment direction of the liquid crystal molecule 32 changes in accordance with an electric field in a state where a high voltage of greater than or equal to a threshold value is applied to the liquid crystal layer LC. In a state where voltage is not applied to the liquid crystal layer LC, the optical axis of the polymer 31 and the optical axis of the liquid crystal molecule 32 are parallel to each other, and light which enters the liquid crystal layer LC is transmitted through the liquid crystal layer LC and is hardly scattered in the liquid crystal layer LC (transparent state). In a state where voltage is applied to the liquid crystal layer LC, the optical axis of the polymer 31 and the optical axis of the liquid crystal molecule 32 cross each other, and light which enters the liquid crystal layer LC is scattered in the liquid crystal layer LC (scattering state).

The display panel PNL includes a display portion DA in which an image is displayed and a frame-shaped non-display portion NDA which surrounds the display portion DA. The sealant SE is located in the non-display portion NDA. The display portion DA includes pixels PX arrayed in a matrix in the first direction X and the second direction Y.

As shown in an enlarged view within FIG. 1, each pixel PX includes a switching element SW, a pixel electrode PE, a common electrode CE, the liquid crystal layer LC and the like. The switching element SW is composed of, for example, a thin-film transistor (TFT) and is electrically connected to a scanning line G and a signal line S. The scanning line G is electrically connected to the switching elements SW in the respective pixels PX arranged in the first direction X. The signal line S is electrically connected to the switching elements SW in the respective pixels PX arranged in the second direction Y. The pixel electrode PE is electrically connected to the switching element SW. The common electrode CE is an electrode common to the pixel electrodes PE. The liquid crystal layer LC (in particular, the liquid crystal molecules 32) is driven by an electric field produced between the pixel electrode PE and the common electrode CE. A storage capacitance CS is formed between, for example, an electrode having the same potential as the common electrode CE and an electrode having the same potential as the pixel electrode PE.

As will be described later, the scanning line G, the signal line S, the switching element SW and the pixel electrode PE are disposed in the first substrate SUB1, and the common electrode CE is disposed in the second substrate SUB2. In the first substrate SUB1, the scanning line G and the signal line S are electrically connected to the wiring substrate 1 or the IC chip 2.

The wiring substrate 1 and the IC chip 2 are mounted on an extension portion Ex of the first substrate SUB1. The extension portion Ex corresponds to a portion of the first substrate SUB1 which does not overlap the second substrate SUB2. The wiring substrate 1 is, for example, a bendable flexible printed circuit. For example, a display driver which outputs a signal necessary for image display or the like is incorporated in the IC chip 2. Note that the IC chip 2 may be mounted on the wiring substrate 1.

The light-emitting module 3 overlaps the extension portion Ex in planar view. The light-emitting module 3 includes a plurality of light-emitting elements LD. The light-emitting elements LD are arranged at intervals in the first direction X.

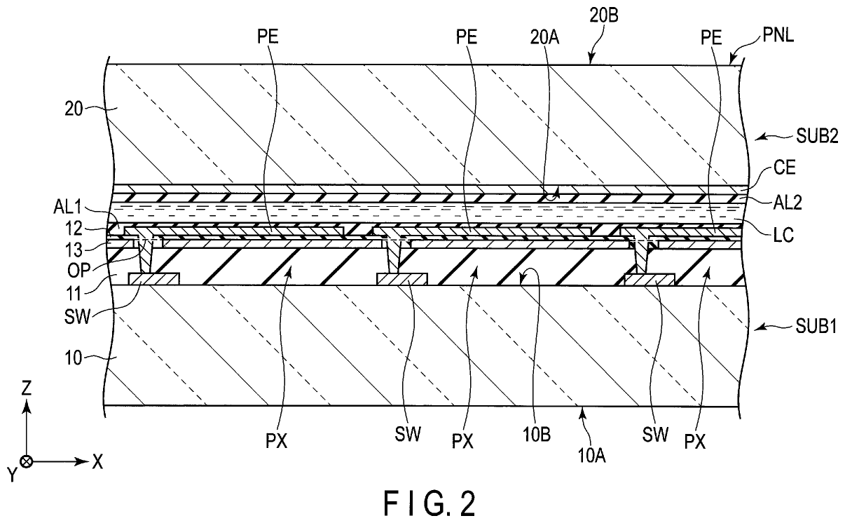

FIG. 2 is a cross-sectional view showing a configuration example of the display panel PNL shown in FIG. 1.

The first substrate SUB1 includes a transparent substrate 10, insulating films 11 and 12, a capacitance electrode 13, the switching element SW, the pixel electrode PE and an alignment film AL1. The transparent substrate 10 has a main surface (outer surface) 10A and a main surface (inner surface) 10B on the opposite side to the main surface 10A. The switching element SW is disposed on the main surface 10B side. The insulating film 11 is disposed on the main surface 10B and covers the switching element SW. Although the scanning line G and the signal line S shown in FIG. 1 are disposed between the transparent substrate 10 and the insulating film 11, the illustrations of them are omitted here. The capacitance electrode 13 is disposed between the insulating films 11 and 12. The pixel electrode PE is disposed for each pixel PX between the insulating film 12 and the alignment film AL1. That is, the capacitance electrode 13 is disposed between the transparent substrate 10 and the pixel electrode PE. The pixel electrode PE is electrically connected to the switching element SW via an opening OP of the capacitance electrode 13. The pixel electrode PE overlaps the capacitance electrode 13 via the insulating film 12 and forms the capacitance CS of the pixel PX. The alignment film AL1 covers the pixel electrode PE. The alignment film AL1 is in contact with the liquid crystal layer LC.

The second substrate SUB2 includes a transparent substrate 20, the common electrode CE and an alignment film AL2. The transparent substrate 20 has a main surface (inner surface) 20A and a main surface (outer surface) 20B on the opposite side to the main surface 20A. The main surface 20A of the transparent substrate 20 faces the main surface 10B of the transparent substrate 10. The common electrode CE is disposed on the main surface 20A. The alignment film AL2 covers the common electrode CE. The alignment film AL2 is in contact with the liquid crystal layer LC. In the second substrate SUB2, a light-shielding layer may be disposed directly above each of the switching element SW, the scanning line G and the signal line S. In addition, a transparent insulating film may be disposed between the transparent substrate 20 and the common electrode CE or between the common electrode CE and the alignment film AL2. The common electrode CE is disposed over the pixels PX and faces the pixel electrodes PX in the third direction Z. In addition, the common electrode CE is electrically connected to the capacitance electrode 13 and has the same potential as the capacitance electrode 13.

The liquid crystal layer LC is located between the pixel electrode PE and the common electrode CE.

Each of the transparent substrates 10 and 20 is, for example, a glass substrate but may be an insulating substrate such as a plastic substrate. The insulating film 11 includes, for example, a transparent inorganic insulating film of silicon oxide, silicon nitride, silicon oxynitride or the like and a transparent organic insulating film of acrylic resin or the like. The insulating film 12 is a transparent organic insulating film of silicon nitride or the like. Each of the capacitance electrode 13, the pixel electrode PE and the common electrode CE is a transparent electrode formed of a transparent conductive material such as indium tin oxide (ITO) or indium zinc oxide (IZO). Each of the alignment films AL1 and AL2 is a horizontal alignment film having an alignment restriction force substantially parallel to the X-Y plane. For example, the alignment films AL1 and AL2 are subjected to alignment treatment in the first direction X. Note that the alignment treatment may be rubbing treatment or may be photoalignment treatment.

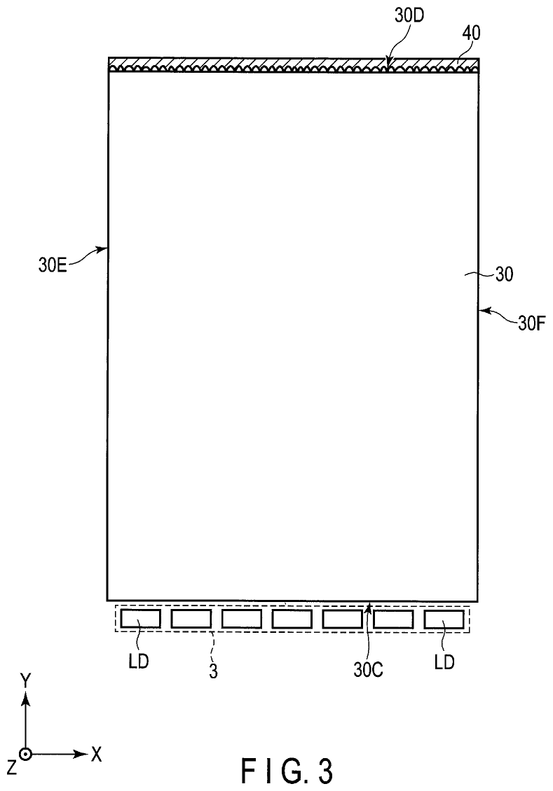

FIG. 3 is a plan view showing a cover glass 30 and the light-emitting module 3 which are applicable to the display device DSP of the present embodiment.

A cover glass 30 has a first side surface 30C and a second side surface 30D which extend in the first direction X and a third side surface 30E and a fourth side surface 30F which extend in the second direction Y. The first side surface 30C and the second side surface 30D face each other in the second direction Y, and the third side surface 30E and the fourth side surface 30F face each other in the first direction X. The first side surface 30C faces the light-emitting elements LD in the second direction Y. A reflector 40 is disposed on the second side surface 30D. The reflector 40 is in close contact with the entire second side surface 30D, and no air layer, adhesive layer or the like is interposed between the reflector 40 and the second side surface 30D. The reflector 40 is not disposed on the first side surface 30C, the third side surface 30E and the fourth side surface 30F. The reflector 40 is formed of, for example, a light reflective metal material such as silver.

In the present embodiment, the surface roughness of the second side surface 30D is greater than the surface roughness of the first side surface 30C. In addition, each of the surface roughness of the third side surface 30E and the surface roughness of the fourth side surface 30F is less than the surface roughness of the second side surface 30D. For example, each of the surface roughness of the third side surface 30E and the surface roughness of the fourth side surface 30F is substantially the same as the surface roughness of the first side surface 30C. That is, in the cover glass 30, the second side surface 30D is a rough surface with minute and random irregularities, and each of the first side surface 30C, the third side surface 30E and the fourth side surface 30F is a flat surface with hardly any irregularities or a mirror surface.

In the present embodiment, arithmetic average roughness (Ra) is used as surface roughness. The surface roughness Ra can be measured by a method prescribed in the JIS B 0601:2001 standard. For example, the second side surface 30D has surface roughness of greater than 0.3 μm. Each of the first side surface 30C, the third side surface 30E and the fourth side surface 30F has surface roughness of less than or equal to 0.3 μm.

From another perspective, when focusing on a haze value indicating a degree of light diffuseness, the second side surface 30D has a larger haze value than the first side surface 30C. In addition, the third side surface 30E and the fourth side surface 30F have substantially the same haze value as the first side surface 30C.

The haze of the present embodiment is defined as the ratio of diffuse transmittance to total light transmittance (haze=diffuse transmittance/total light transmittance). The haze value can be measured by, for example, a haze meter. For example, the second side surface 30D has a haze value of greater than or equal to 10%. Each of the first side surface 30C, the third side surface 30E and the fourth side surface 30F has a haze value of less than 10%. That is, the second side surface 30D has higher light diffuseness than the first side surface 30C. When visually observed, the second side surface 30D is substantially opaque such as frosted glass, and the first side surface 30C, the third side surface 30E and the fourth side surface 30F are substantially transparent.

The cover glass 30 having the second side surface 30D which is the above-described rough surface can be formed as follows. For example, the rough surface can be formed by chemically processing the second side surface 30D using hydrofluoric acid. Alternatively, the rough surface can be formed by mechanically processing the second side surface 30D using a grindstone having a grain size of #600 to #800. Subsequently, the reflector 40 can be formed by evaporating a metal material such as silver onto the second side surface 30D. The above-described cover glass 30 will be bonded to the display panel PNL later.

Note that the third side surface 30E and the fourth side surface 30F may be substantially the same rough surfaces as the second side surface 30D and the reflector 40 may be disposed on the third side surface 30E and the fourth side surface 30F.

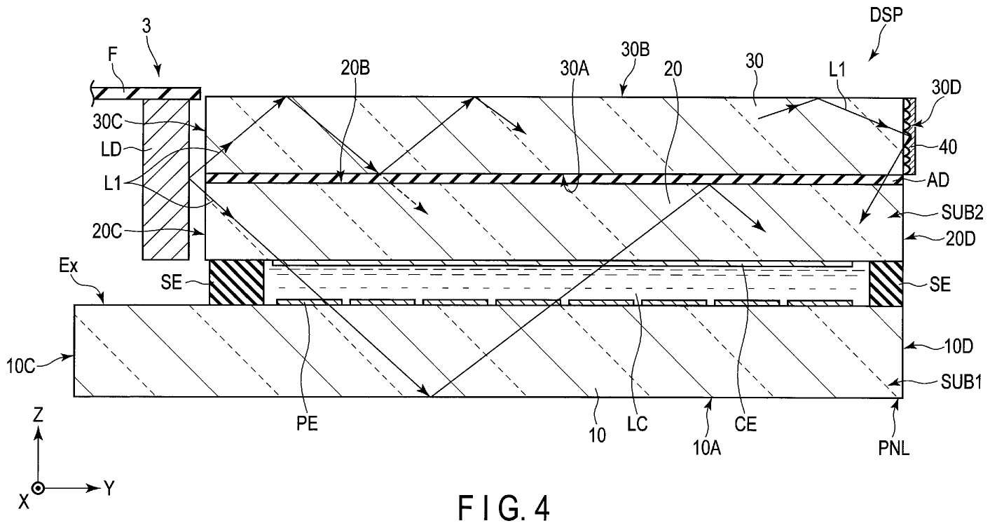

FIG. 4 is a cross-sectional view showing a configuration example of the display device DSP of the present embodiment. With regard to the display panel PNL, only its main parts are illustrated.

The transparent substrate (first transparent substrate) 10 has a side surface 100 and a side surface 10D which face each other in the second direction Y. The transparent substrate (second transparent substrate) 20 has a side surface (fifth side surface) 20C and a side surface (sixth side surface) 20D which face each other in the second direction Y. The extension portion Ex of the first substrate SUB1 corresponds to a region between the side surface 100 and the side surface 20C. The side surface 10D and the side surface 20D overlap in the third direction Z.

The cover glass 30 is bonded to the display panel PNL by an adhesive layer AD. That is, the cover glass 30 has a main surface (inner surface) 30A and a main surface (outer surface) 30B which face each other in the third direction Z. The adhesive layer AD is transparent and is interposed between the main surface 20B of the transparent substrate 20 and the main surface 30A of the cover glass 30. The cover glass 30 has substantially the same refractive index as the transparent substrates 10 and 20. The refractive index of the adhesive layer AD is less than the refractive index of the cover glass 30.

In the example shown in FIG. 4, the first side surface 30C of the cover glass 30 overlaps the side surface 20C of the transparent substrate 20 in the third direction Z. In addition, the second side surface 30D overlaps the side surface 10D of the transparent substrate 10 and the side surface 20D of the transparent substrate 20 in the third direction Z. However, there is a case where the first side surface 30C is displaced in the second direction Y with respect to the side surface 20C, and there is a case where the second side surface 30D is displaced in the second direction Y with respect to the side surface 20D.

The surface roughness of the second side surface 30D is greater than the surface roughness of the first side surface 30C and is greater than the surface roughness of the side surfaces 100 and 10D and the side surfaces 20C and 20D.

The reflector 40 disposed on the second side surface 30D is not in contact with the adhesive layer AD. In addition, the reflector 40 is not in contact with the transparent substrates 10 and 20 and the sealant SE. Note that a reflector other than the reflector 40 (for example, a reflective tape bonded via an adhesive layer) may be disposed on the side surface 10D and the side surface 20D.

The light-emitting module 3 is disposed on the extension portion Ex. The light-emitting element LD overlaps the transparent substrate 10 and is electrically connected to a wiring substrate F. The light-emitting element LD is, for example, a light-emitting diode, and although not described in detail, the light-emitting element LD includes a red light-emitting portion, a green light-emitting portion and a blue light-emitting portion. The light-emitting element LD is disposed between the first substrate SUB1 and the wiring substrate F in the third direction Z. In addition, the light-emitting element LD faces the side surface 20C and the first side surface 30C in the second direction Y and emits light toward the side surface 20C and the first side surface 30C. Note that a transparent light guide may be disposed between the light-emitting element LD and each of the side surface 20C and the first side surface 30C.

Next, light L1 emitted from the light-emitting element LD will be described with reference to FIG. 4.

The light-emitting element LD emits light L1 toward the side surface 20C and the first side surface 30C. The light L1 propagates in the direction of an arrow indicating the second direction Y, and enters the transparent substrate 20 from the side surface 20C and also enters the cover glass 30 from the first side surface 30C. The light L1 propagates through the display panel PNL while being repeatedly reflected within the display panel PNL. The light L1 entering the liquid crystal layer LC to which voltage is not applied is transmitted through the liquid crystal layer LC and is hardly scattered in the liquid crystal layer LC. In addition, the light L1 entering the liquid crystal layer LC to which voltage is applied is scattered in the liquid crystal layer LC. The display device DSP can be observed from the main surface 10A side and can also be observed from the main surface 30B side. In addition, irrespective of whether the display device DSP is observed from the main surface 10A side or the display device DSP is observed from the main surface 30B side, the background of the display device DSP can be observed via the display device DSP.

Incidentally, the refractive index of the adhesive layer AD is less than the refractive index of the cover glass 30 as described above. Therefore, the light L1 entering the cover glass 30 is reflected at the interface between the adhesive layer AD and the cover glass 30 and is less likely to reach the transparent substrate 20 and the liquid crystal layer LC. In other words, with regard to the light L1 propagating through the cover glass 30, most of light which reaches the main surface 30A is totally internally reflected and only light which is incident at an angle deviating from total internal reflection conditions reaches the transparent substrate 20 and the liquid crystal layer LC. In the cover glass 30, the light L1 propagating while being repeatedly reflected reaches the second side surface 30D. Since the second side surface 30D is covered with the reflector 40, the light L1 reaching the second side surface 30D is reflected by the reflector 40 and reenters the cover glass 30. At this time, since the second side surface 30D is a rough surface, the light entering the cover glass 30 includes the above-described light which is incident at an angle deviating from total internal reflection conditions, reaches the transparent substrate 20 and the liquid crystal layer LC, and contributes to display.

In a comparative example where the second side surface 30D is not a rough surface or is not covered with the reflector 40, the light L1 reaching the second side surface 30D leaks to the outside of the cover glass 30 without contributing to display. In addition, even when the second side surface 30D is covered with the reflector 40, if the second side surface 30D is not a rough surface, the reflected light from the reflector 40 propagates through the cover glass 30 while being totally internally reflected within the cover glass 30 again and does not contribute to display.

According to the present embodiment, as compared to the comparative example, the light leaking from the cover glass 30 can be used as light contributing to display, and the light use efficiency can be improved.

Furthermore, in the cover glass 30, the reflector 40 is disposed on the opposite side to the position of the light-emitting module 3, and in the display panel PNL, a region on the opposite side to the position of the light-emitting module 3 is irradiated with the reflected light from the reflector 40. Therefore, the luminance of a region which is distant from the light-emitting module 3 can be improved. Consequently, as compared to the comparative example, the difference between the luminance of a region close to the light-emitting module 3 and the luminance of a region distant from the light-emitting module 3 can be reduced, and the degradation in display quality can be suppressed.

When the display panel PNL and the cover glass 30 are bonded together, from the perspective of facilitation of the entry of the light L1 from the light-emitting element LD to the display panel PNL and the cover glass 30, the first side surface 30C should preferably be located directly above the side surface 20C. On the other hand, there is a case where the second side surface 30D is displaced with respect to the side surface 20D.

In the case of bonding a reflective tape to the side surface 10D, the side surface 20D and the second side surface 30D for the purpose of suppressing the leakage of light from these side surfaces, it may be difficult to uniformly bond a reflective tape due to the displacement of the second side surface 30D with respect to the side surface 20D. In addition, an air layer may be interposed in the gap between the side surface 20D and the second side surface 30D, and the adhesiveness of the reflective tape may be degraded or the reflected light from the reflective tape may become non-uniform.

In the present embodiment, the cover glass 30 comprising the reflector 40 which is bonded to the second side surface 30D in advance is bonded to the display panel PNL. Therefore, it is not necessary to bond a reflective tape over the side surface 20D and the second side surface 30D. Consequently, the above-described problems can be solved.

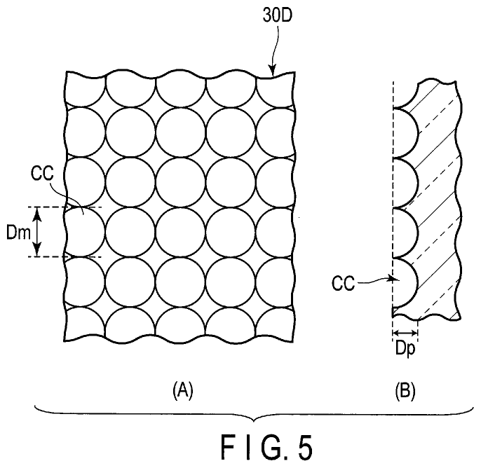

FIG. 5 is an illustration showing a configuration example of the second side surface 30D. FIG. 5 (A) is a plan view and FIG. 5 (B) is a cross-sectional view.

The second side surface 30D has a plurality of concavities CC. The concavities CC have a diameter Dm and a depth Dp. For example, the diameter Dm is less than or equal to 0.3 μm. In the example shown in FIG. 5, the concavities CC are regularly arranged in a matrix. However, the concavities CC are not limited to this example. In addition, the concavities CC have the same diameter Dm, but concavities CC adjacent to each other may have diameters Dm different from each other. Furthermore, the concavities CC have the same depth Dp, but concavities CC adjacent to each other may have depths Dp different from each other.

On the second side surface 30D on which the above-described concavities CC are formed, light is more likely to be scattered, and the transmittance is reduced. In other words, when reaching the second side surface 30D on which the concavities CC are formed, the light propagating through the cover glass 30 is less likely to be transmitted through the second side surface 30D and is more likely to be reflected by the second side surface 30D. That is, as compared to a case where the second side surface 30D is a mirror surface, the amount of light reflected by the second side surface 30D is increased, and the light reaching the second side surface 30D is reused.

In addition, according to the present embodiment, the second side surface 30D is covered with the reflector 40. Therefore, the light transmitted through the second side surface 30D is also reflected by the reflector 40 and reused.

As described above, according to the present embodiment, a cover glass and a display device which can suppress leakage of light can be provided.

While a certain embodiment has been described, the embodiment has been presented by way of example only, and is not intended to limit the scope of the invention. Indeed, the novel embodiment described herein may be embodied in a variety of other forms; furthermore, various omissions, substitutions and changes in the form of the embodiment described herein may be made without departing from the spirit of the invention. The accompanying claims and their equivalents are intended to cover such forms or modifications as would fall within the scope and spirit of the invention.

What is claimed is:

1. A cover glass having a first side surface and a second side surface facing the first side surface, wherein
a reflector is disposed on the second side surface,
the reflector is not disposed on the first side surface, and
surface roughness of the second side surface is greater than surface roughness of the first side surface.

2. The cover glass of claim 1, further having a third side surface and a fourth side surface facing each other, wherein
each of surface roughness of the third side surface and surface roughness of the fourth side surface is less than surface roughness of the second side surface, and
the reflector is not disposed on the third side surface and the fourth side surface.

3. The cover glass of claim 1, wherein
the first side surface has surface roughness of less than or equal to 0.3 μm, and
the second side surface has surface roughness of greater than 0.3 μm.

4. The cover glass of claim 1, wherein
the first side surface has a haze value of less than 10%, and
the second side surface has a haze value of greater than or equal to 10%.

5. A display device comprising:
a light-emitting element;
a cover glass having a first side surface facing the light-emitting element and a second side surface facing the first side surface;
a display panel comprising a polymer dispersed liquid crystal layer; and
an adhesive layer bonding the cover glass and the display panel together, wherein
surface roughness of the second side surface is greater than surface roughness of the first side surface.

6. The display device of claim 5, wherein a reflective index of the adhesive layer is less than a refractive index of the cover glass.

7. The display device of claim 5, further comprising a reflector disposed on the second side surface.

8. The display device of claim 7, wherein the reflector is not in contact with the adhesive layer.

9. The display device of claim 5, wherein
the first side surface has surface roughness of less than or equal to 0.3 μm, and
the second side surface has surface roughness of greater than 0.3 μm.

10. The display device of claim 5, wherein
the first side surface has a haze value of less than 10%, and
the second side surface has a haze value of greater than or equal to 10%.

11. The display device of claim 5, wherein
the display panel comprises a first transparent substrate and a second transparent substrate,
the polymer dispersed liquid crystal layer is held between the first transparent substrate and the second transparent substrate, and
the light-emitting element overlaps the first transparent substrate and faces a fifth side surface of the second transparent substrate.

12. The display device of claim 11, wherein the adhesive layer bonds the cover glass and the second transparent substrate together.

13. The display device of claim 12, wherein the first side surface overlaps the fifth side surface.

14. The display device of claim 13, wherein
the second transparent substrate has a sixth side surface on an opposite side to the fifth side surface,
the second side surface overlaps the sixth side surface, and
surface roughness of the second side surface is greater than surface roughness of the sixth side surface.
